(19) United States
(12) Patent Application Publication
(10) Pub. No.: US 2005/0099649 A1
(43) Pub. Date: May 12, 2005

(54) Load balanced document splitting by weighting pages

(75) Inventors: Andrew Rodney Ferlitsch, Tigard, OR (US); Charles Michael Pickett, Brush Prairie, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/702,273

(22) Filed: Nov. 6, 2003

(51) Int. Cl. G06F 15/00

(52) U.S. Cl. 358/1.15

(57) ABSTRACT

A computer based printing system, comprised of one or more print drivers, a spooler, print processor, two or more printing devices and optionally one or more print servers. The system results in reducing uneven distribution of load across printers for document splitting in a cluster printing environment, by weighting each page for the approximate proportional load required for the respective printer(s) to PDL interpretation/RIP. The system has the advantage of not requiring additional hardware, firmware, or server side software, by having the load calculated, splitting and distribution in the client side print subsystem. The method of the invention includes a method of distributing a print job having plural pages to plural printers, wherein each printer has a printer description language interface, selecting a cluster printing option and the printers to be used during distributed printing; analyzing the print job to estimate print times for each page of the print job; assigning a print job weight to each page as a function of the page's proportional page description language/raster image process time; and balancing a page distribution to each selected printer as a function of a printer's rated speed to have the distributed print job substantially simultaneously complete on each selected printer.

### FIELD OF THE INVENTION

This invention relates to printer job distribution, and specifically a technique of routing printing of individual pages according to the content of the page to be printed. Splitting the printing of a document across multiple printers, i.e., cluster printing—document splitting, wherein the number of pages per printer is allocated such that the load is evenly balanced across the printers according to the printer's rated speed, sometimes referred to as rated performance, such as the print engine page per minute (PPM) speed, is a technique used to increase print speed beyond that of a single printer's print engine.

### BACKGROUND OF THE INVENTION

U.S. Pat. No. 5,859,711, granted Jan. 12, 1999, to Barry et al., for Multiple print engine with virtual job routing, describes load balancing jobs and copies vs. pages, of multiple jobs. Basically, un-RIP'd (raster image processed) jobs are sent to a central spooler for printing. The spooler sends the jobs to a software RIP, instead of sending the jobs to a printer. The RIP makes mini jobs, one per job, and/or one per copy of job, and RIPs the data. The mini, pre-RIP'd jobs are then distributed to multiple printers.

There are several examples of cluster printer products available today, however, few provide document splitting, and none of the known examples provide an even distribution to plural printers when the page or sheet distribution are an uneven distribution of page description language (PDL) interpretation/RIP time, as shown in Prior Art FIGS. 1 and 2. FIG. 1 depicts a three-page print job, which begins with print job commands (PJCs), a page one preamble and page one data. Pages two and three each contain a preamble and data. FIG. 2 depicts a similar print job wherein page 1 includes bitmap data.

For example, Sharp's EZ Cluster® 1.0 provides document splitting capability across multiple printers, as described in United States Patent Publication No. 20020089691, for Methods and systems for printing device load balancing, published Jul. 11, 2002. The product load balances the number of sheets distributed to each printer according to the printer's PPM speed. However, as shown in FIG. 3, pages of various lengths, i.e., having differing amounts of commands and data, result in different total print time on each of the selected printers, resulting in different completion times. A 20 page document, wherein the pages of are of approximate equal length, split across 3 printers with the specified PPM below, would be distributed as follows:

TABLE 1

| Printer | PPM | No. of Pages |
|---|---|---|
| P1 | 50 | 1 . . . 10 (10 pages) |
| P2 | 25 | 11 . . . 15 (5 pages) |
| P3 | 25 | 16 . . . 20 (5 pages) |

In the above example, the distribution assumes that either: (1) the pages are pre-RIP'd, i.e., no PDL interpretation/RIP is required by the printer; or (2) the pages require roughly equal time to PDL interpretation/RIP on the printer.

If the document pages are not pre-ripped and the amount of print data per page is not evenly distributed, the above method of distributing pages (sheets) to multiple printers will result in an uneven distribution of pages to the corresponding printers. For example, if a large document contains a number of pages of having complex graphics and the remaining pages contained text only, the time to PDL interpretation/RIP on the printer for the pages with graphics would be substantially longer than the text-only pages. If the pages are distributed simply by the number of pages, the distributions with the graphic intensive pages would take substantially longer to complete than the text only distributions.

TABLE 2

| Load Balance by Page Weighting - | | Load Balance by Number |
|---|---|---|
| method of the invention | | of Pages - Prior Art |
| Document Splitting of Pages/Sheets: | Yes | Yes |
| Balanced Distribution for Equal Pages: | Yes | Yes |
| Balanced Distribution for Non-Equal | Yes | No |
| Pages: | | |
| Consideration of Page Size: | Yes | No |
| Consideration of Print Job Header: | Yes | No |
| Consideration of Non-Page Data: | Yes | No |
| Consideration of Page Cmd Weighting: | Yes | No |

### SUMMARY OF THE INVENTION

A computer based printing system, comprised of one or more print drivers, a spooler, print processor, two or more printing devices and optionally one or more print servers. The system results in reducing uneven distribution of load across printers for document splitting in a cluster printing environment, by weighting each page for the approximate proportional load required for the respective printer(s) to PDL interpretation/RIP. The system has the advantage of not requiring additional hardware, firmware, or server side software, by having the load calculated, split and distributed by the client-side print subsystem. The method of the invention includes a method of distributing a print job having plural pages to plural printers, wherein each printer has a printer description language interface, selecting a cluster printing option and the printers to be used during distributed printing; analyzing the print job to estimate print times for each page of the print job; assigning a print job weight to each page as a function of the page's proportional page description language/raster image process time; and balancing a page distribution to each selected printer as a function of a printer's rated speed to have the distributed print job substantially simultaneously complete on each selected printer.

It is an object of the invention to provide a method of distributing a multi-page and/or multi-copy print job among several printers to complete printing in a shorter time period than if the print job were sent to a single printer.

Another object of the invention is to provide several techniques for weighting the pages of a print job to determine how best to distribute the print job among several printers.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 depicts a Prior Art PJC+Preamble and data for each page font set.

FIG. 2 depicts a Prior Art PJC wherein page one includes bitmaps data.

FIG. 3 depicts Prior Art page distribution scheme.

FIG. 4 is a block diagram of the method of the invention.

FIG. 4 depicts a document split by load balancing by number of pages having uneven distribution.

FIG. 5 depicts a document split by load balancing by page size having approximate even distribution.

FIG. 6 depicts load balancing by page size having skewed by font downloads and PJL on page 1 of the print job.

FIG. 7 depicts load balance by page size having separate out font downloads and PJL with even distribution.

FIG. 8 depicts load balance by page size having font downloads and PJL carry over with even distribution.

FIG. 9 depicts load balance by page data size after filtering out of PJL and non-page data.

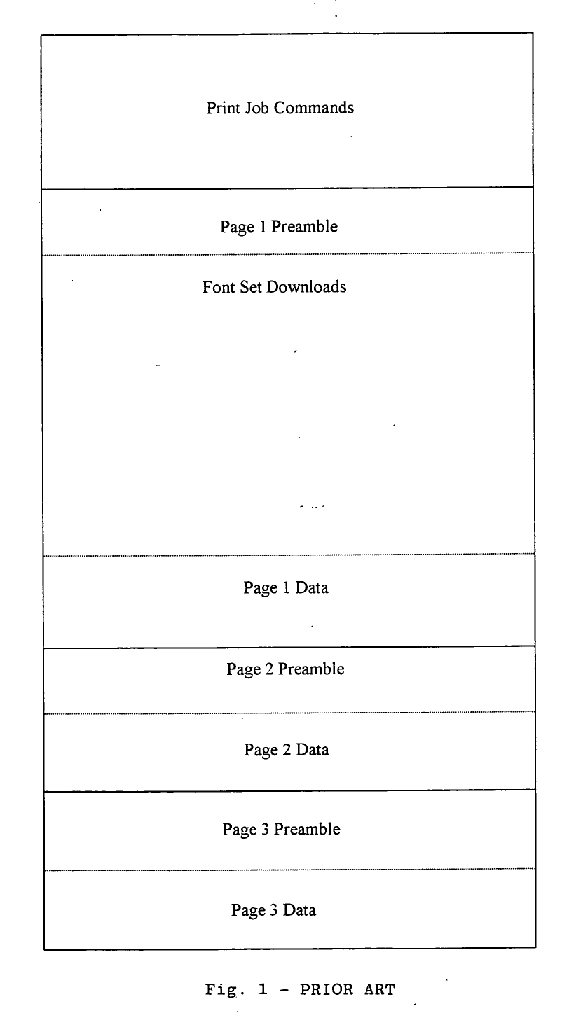

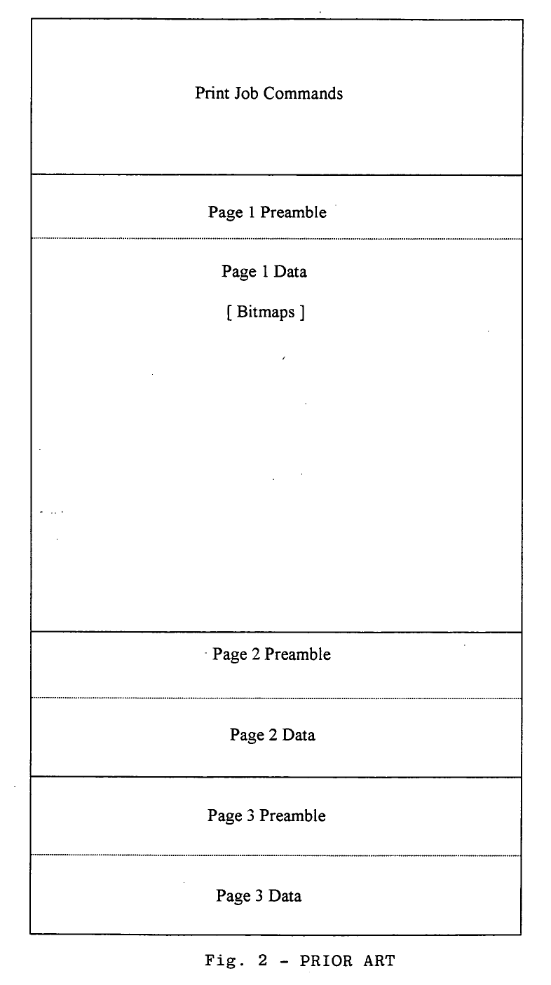

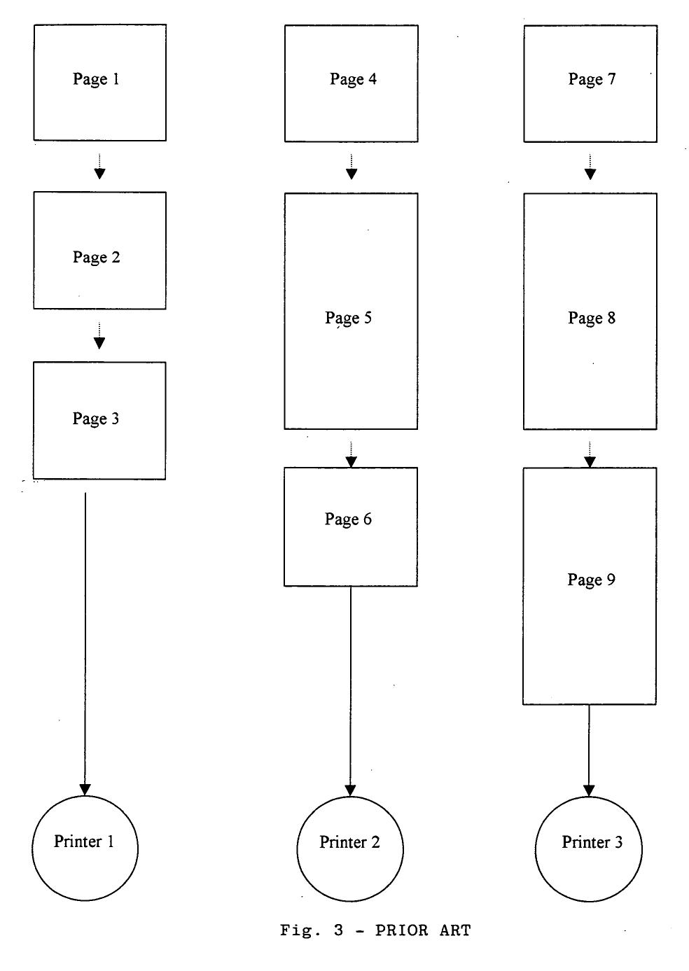

### DETAILED DESCRIPTION OF THE PREFERRED EMBODIMENT

The invention improves the problem of load balancing a document split across multiple printers, such that each printer completes its portion of a print job at the same, or near, the same time, ie., substantially simultaneously. Ideally, if all printers receive a distributed portion of a print task at the same time, all printers will complete the printing of their distribution at the same time.

An important feature of the method of the invention is to provide a printing system with the ability to distinguish pages whose page description language (PDL) interpretation/raster image processor (RIP) requirements will result in an uneven distribution of load. The method of the invention disclosed herein assigns a print job weight to each page that approximates the proportional load-to-PDL interpretation/RIP in the printing device. The pages are distributed to each of the user-selected printers as a function of the assigned page weight. Three weighting methods are disclosed as preferred embodiments of the method of the invention, however, one of ordinary skill in the art will recognize that other embodiments fall within the scope of the invention. The three embodiments include:
1. Distribution by page or file size;
2. Distribution by page data or imaging commands size; and
3. Distribution by page command weights.
   Load Balanced by Page Weighting for Document Splitting in Cluster Printing Environment.

A system to perform the method of the invention includes two or more compatible printers i.e., identical PDL interpreters and required finishing/assembly capabilities, connected in a local, remote or network print environment, a computing device capable of spooling a print job, and a printer driver and print processor compatible with the printing devices, such as the printer drivers and print processors of the Microsoft Windows 9x, NT and 2K operating systems.

A user initiates a print job having of one or more documents, each document having one or more pages, and collectively including of one or more copies of each print job. The print job may be preprocessed into printer-ready data, such as an application rendering its output into a PDL, such as printer control language (PCL) (Hewlett-Packard), Postscript® (Adobe Systems, Inc.), portable document format (PDF) (Adobe Systems, Inc.,—Acrobat®) and tagged image file format (TIFF). The print job may also be journaled, wherein the rendering instructions are recorded, and the playback of the rendering instructions is deferred, e.g., Enhanced Meta File (EMF) (Microsoft Corp.) and Printer Meta File (PMF) (Sharp Corp.).

Generally, to initiate a print job, the user selects a command, or sequence of commands, and/or stimuli, to the computing device to which the user intends to spool a print job. The computing device responds to the user by presenting the user a dialog box, e.g., a printer user interface (UI), command line query, or front panel display, which the user may use to select options relating to the spooling of the print job. One of the usual options is the selection of a printing device, e.g., printer, plotter, multi-function peripheral (MFP), or CD/DVD burner. Once the printing device is selected, the computing device responds by loading the printer driver and print processor associated with the printing device, and the printer driver responds, automatically or by user initiation, to the user by presenting the user a dialog box, in which the user may select options relating to the printing device's capabilities; e.g., print quality, paper size, orientation, tray selection, manual feed, duplexing, collation, stapling, hole punching, watermarks. If the document to be printed is already in a print-ready format, the document does not need to go through the printer driver, and may be sent directly to a print engine.

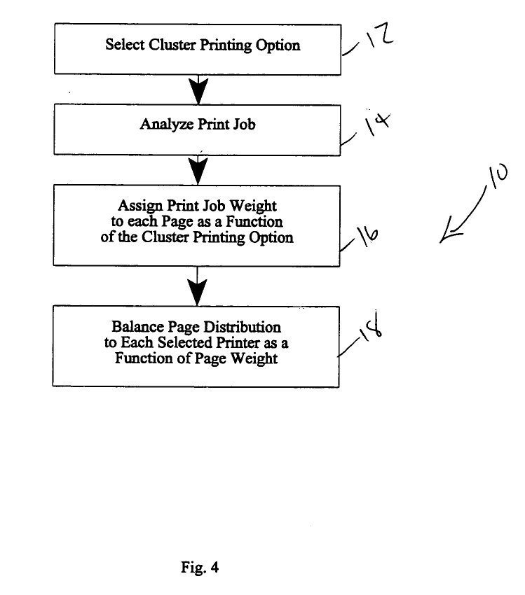

In the method of the invention, generally shown at 10 in FIG. 4, the choices presented to the user for selecting options specific to the printing device's capabilities, includes a dialog box for cluster printing, which allows a user to select whether a cluster printing option, i.e., distribution of the print job among plural printers, is to be used, 12. Alternate embodiments of the method of the invention provide the user with a dialog box for selecting cluster specific options may be presented by an application, background process, print processor, spooler, print assistant, i.e., any component not otherwise part of the print subsystem that is inserted into the printing process, or be pre-specified.

Within the dialog box, the user may optionally select to split the print job across multiple printing devices, i.e., document splitting, and/or split copies of the print job across multiple printing devices, i.e., copy splitting, or route the print job to the best fit printer, i.e., pool printing. A display of all the available printing devices in the cluster and each printer's capabilities, such as PPM, duplexing, collation, stapling, paper selection, input/output trays, etc., is provided to allow the user to select one or more options for despooling the print job.

Once the user has completed selecting options specific to both the print job and the printing device(s), the computing device initiates spooling of the print job, including analysis of the print job, 14. Spooling the print job to the printer driver includes: 1) constructing print job specific information, e.g., DEVMODE in Microsoft Operating Systems, 2) compilation of rendering instructions, and 3) rendering, i.e., converting preprocessed data into printer-ready data, or 4) recording the print job for deferred playback, i.e., journaling. The print job may be partly or entirely rendered into printer-ready data, in which case, the step of compiling rendering instructions may be skipped partly or entirely. The output from the print driver, i.e., the spooled print job, may also contain information regarding the cluster options selected for the print job, including splitting of the print job, and/or splitting copies of the print job, and the list of selected printers to which the print job is to be despooled. The output for the computation device is generally referred to as a spool file, and the contents thereof generally referred to as spool data, which may be located on a hard disk, in memory, in a cache, or in some other form of storage compatible with the computing device.

Once the spool file is completed, the spooler despools, immediately or delayed, the spool file to the associated print processor for the selected printing device(s). The print processor reads the spool file and determines if the content is preprocessed printer-ready data, e.g., RAW mode in the Microsoft Operating Systems, or journaled, e.g., EMF mode in the Microsoft Operating System. If the print data is printer-ready data, the print processor writes the print data directly to the port manager(s) of the corresponding printing device(s); otherwise, the print processor plays back the journaled data to the printer driver(s) associated with the corresponding printing device(s). The printer driver(s) then render the journaled data and spools the printer-ready data to the spooler. The spooler then writes the printer-ready data directly to the port manager(s) of the corresponding printing device(s). The method of the invention disclosed herein assigns a print job weight to each page that approximates the proportional load-to-PDL interpretation/RIP in the printing device, 16. The pages are distributed to each of the user-selected printers as a function of the assigned page weight, 18.

Document Splitting—Load Balance by Page (File) Size

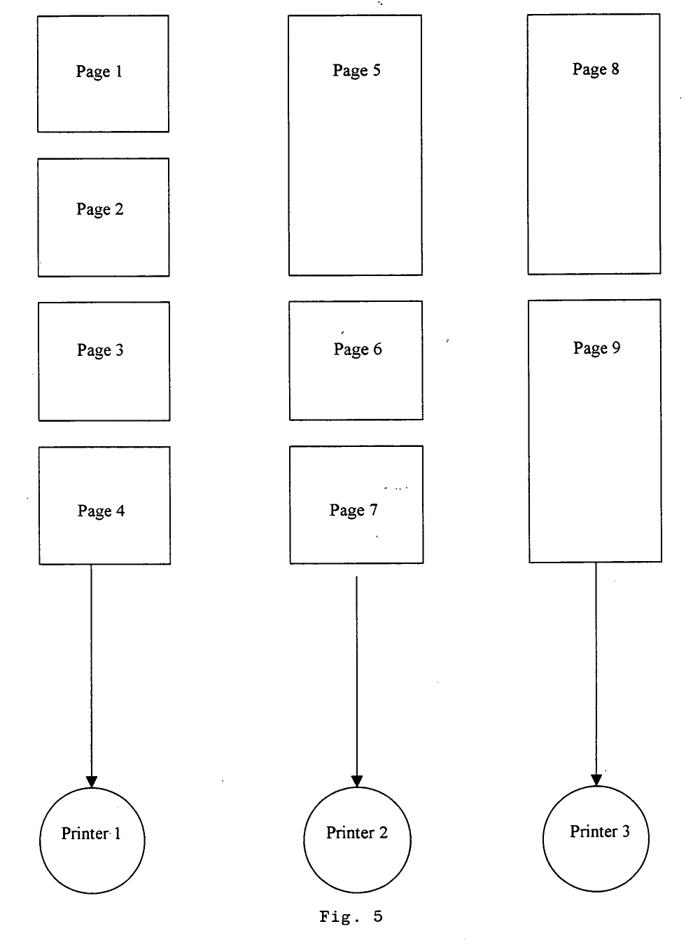

Referring now to FIG. 5, an example of document splitting using a load balance by page (file) size weighting protocol is depicted. In this embodiment of the method of the invention, a component in the print subsystem, such as the printer driver, spooler, print processor or print assist, performs the clustering tasks. The print processor may be used as an example to illustrate this. Assume that, for purposes of the example, the print data is printer-ready. In an alternate embodiment, to be described later herein, the print data is journaled data.

The print processor determines, from the selected clustering options, that the print job is to be document-split. In document splitting, the pages of the document to be printed are split across multiple printing devices. Generally, the distribution is based on the printer's print engine speed, i.e., PPM. For example, if a 100 page document is split across two printers of equal speed, the pages might be distributed as:

| | |
|---|---|
| Printer 1 | pages 1 . . . 50 |
| Printer 2 | pages 51 . . . 100 |

If the pages are fully rasterized, i.e., RIP'd, no additional processing occurs in the printing device, and the pages print at full print engine speed.

If the pages are not pre-RIP'd, the print data must first be rasterized in the printing device. Generally, rasterization consumes additional resources of the printing device, causing the output to print at less than print engine speed. The amount of resources consumed, e.g., time, is relative to the degree of complexity and size of the data to be RIP'd. For example, a page containing only text will take little time to RIP, however, a page having complex and detailed photographs will take a considerable amount of time to RIP. Therefore, a distribution on a non-RIP'd document, based only on PPM speed, may not result in an even time-to-print distribution of load to the printing device(s).

This embodiment of the method of the invention improves page-size distribution by assigning a weight to each page for its proportion of PDL interpretation/RIP in a printing device. In the case where the pages were pre-RIP'd, the weight assigned to each page may be assumed to be 1 (normalized). Thus, the distribution for pre-RIP'd jobs, is calculated as, where N is the number of printers:

$$\begin{matrix}{PPM}_{Total} = {\sum }_{i = 1}^{N} {PPM}_{i} & \# Total PPM of the Printer Cluster \\ for i = 1 to N & \begin{matrix} \# Distribution of Sheets to each Printer in \\ the Cluster \end{matrix}\end{matrix}$$

$$do$$

$${nSheets}_{i} = ( {PPM}_{i} / {PPM}_{Total} ) * {nSheets}_{Total}$$

$$done$$

In the above formulae, the number of sheets printed may be calculated from the number of pages and the sheet assembly options, as:

```
# Simplex: Sheets = Pages
#
nSheets_{Total} = nPages_{Total}
# Simplex: Number of Pages per Sheet = Nup
#
nPagesPerSheet = Nup
# Booklet Printing
#
if ( booklet )
{
    # Booklet Printing = 2 sided printing with Nup = 2
    #
    duplex = true
    Nup / * 2
}
# Duplex: 2 sided printing.
#
if ( duplex )
{
    # Duplex: Number of Pages per Sheet = Nup * 2
    #
    nPagesPerSheet *= 2
}
# Sheets = pages per sheet
#
nSheets_{Total} /= nPagesPerSheet
# Uneven division of pages per sheet ( not enough pages to fill last sheet )
#
if ( nPages_{Total} % nPagesPerSheet )
{
    # Last Sheet has partial number of nPagesPerSheet
    #
    nSheets_{Total} += 1
}
```

In this embodiment of the method of the invention, the PDL interpretation/RIP load is assumed to be proportional to the size of print data per page. For example, if the print data for a page is 10 times greater (a 10× page) than that of another page (a IX page), then it is assumed that it will take 10 times longer to PDL interpret/RIP for the 10× page in the printing device than for the 1× page.

The first step in PDL interpret/RIP loading is to split the print data into pages. Typically, a print job is parsed and page boundaries are located. The pages are grouped together into sheets based on sheet assembly options, previously described herein. The print job is split into individual sections based on sheet boundaries. Each sheet is assigned a weight according to its size, e.g., byte size. It will be appreciated that during final reassembly into page sequences, some additional data may need to be added, such as print job options and page persistent data. Thus, the distribution of pages based on page size may be calculated as, where M is the number of sheets:

| | |
|---|---|
| ${Weight}_{Total} = {\sum }_{i = 1}^{M} Sheet {Size}_{j}$ | # Total Weight of all Sheets in the Document |

| | |
|---|---|
| for i = 1 to N | # Distribution of Weight to each Printer in the Cluster |
| do | |

Weightᵢ = (PPMᵢ/PPM_{Total}) * Weight_{Total}

done
# Distribute Sheets to Printer based on proportion of sheet weight
# First Sheet to Distribute
#
first=1
# Distribute Sheets to Each Printer in the Cluster
#
for i = 1 to N
do

# Weight Accumulator for this Printer
#
weight = 0
# Distribute Sheets to this Printer
#
for j = first to M
do

# Stop distributing Sheets when Weight Accumulator equals (exceeds)
# weight
# distributed to this Printer
#
if weight >= Weightᵢ
then

break

if
# Add Weight of this Sheet to Weight Accumulator for this Printer
#
weight += Weightᵢ

done
# Distribute the Sheets to this Printer
#
nSheetsᵢ = j − first + 1
# Advance to the next page to start a new page sequence
#
first = nSheetsᵢ + 1

done

TABLE 3
Load Balance by Page/File Size

| | | Load Balance by |
|---|---|---|
| Load Balance by Page Weighting | | Page (File) Size |
| Document Splitting of Pages/Sheets: | Yes | Yes |
| Balanced Distribution for Equal Pages: | Yes | Yes |
| Balanced Distribution for Non-Equal | Yes | Yes/No (Approx.) |
| Pages: | | |
| Consideration of Page Size: | Yes | Yes |
| Consideration of Print Job Header: | Yes | Yes/No (PJL header |
| | | could be filtered) |
| Consideration of Non-Page Data: | Yes | No |
| Consideration of Page Cmd Weighting: | Yes | No |

Document Splitting—Load Balance by Page Data Size

The above load balance by page/file size method of the invention, generally produces an approximate even distribution, but may not always produce an evenly balanced distribution. The load balance by page/file size method of the invention assumes that all the data for each page requires equal time for PDL interpretation/RIP. If each page includes only page data, then the load balance by page/file size method of the invention will result in an approximate even balanced distribution.

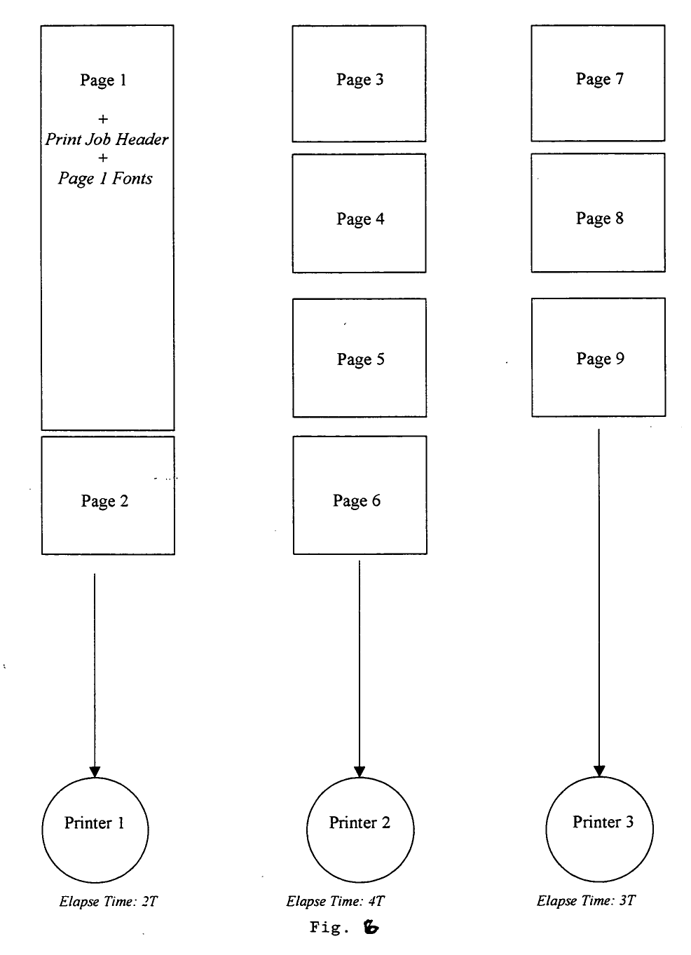

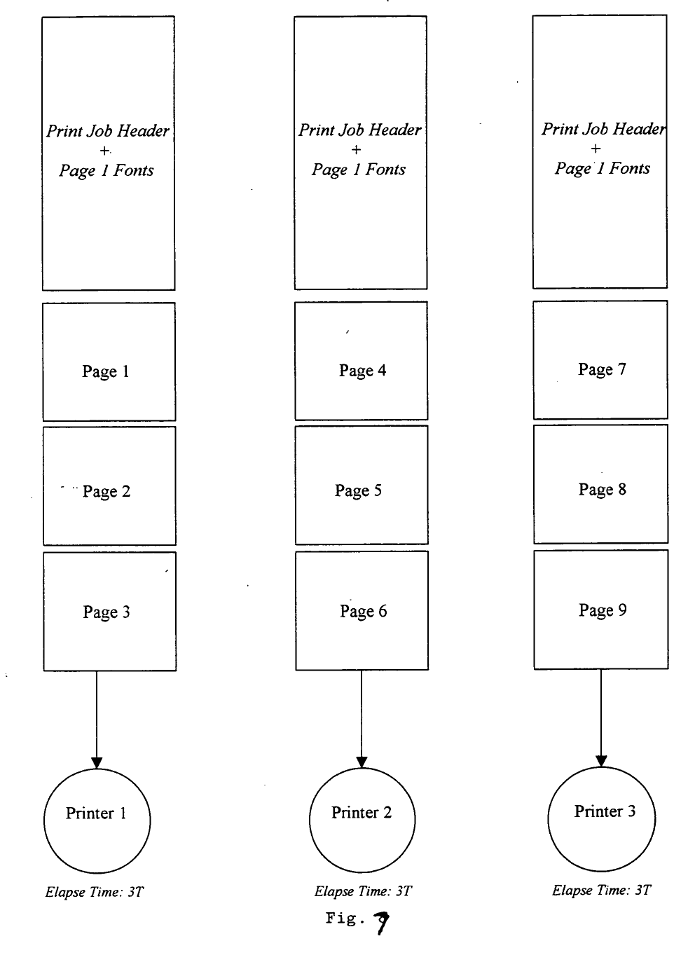

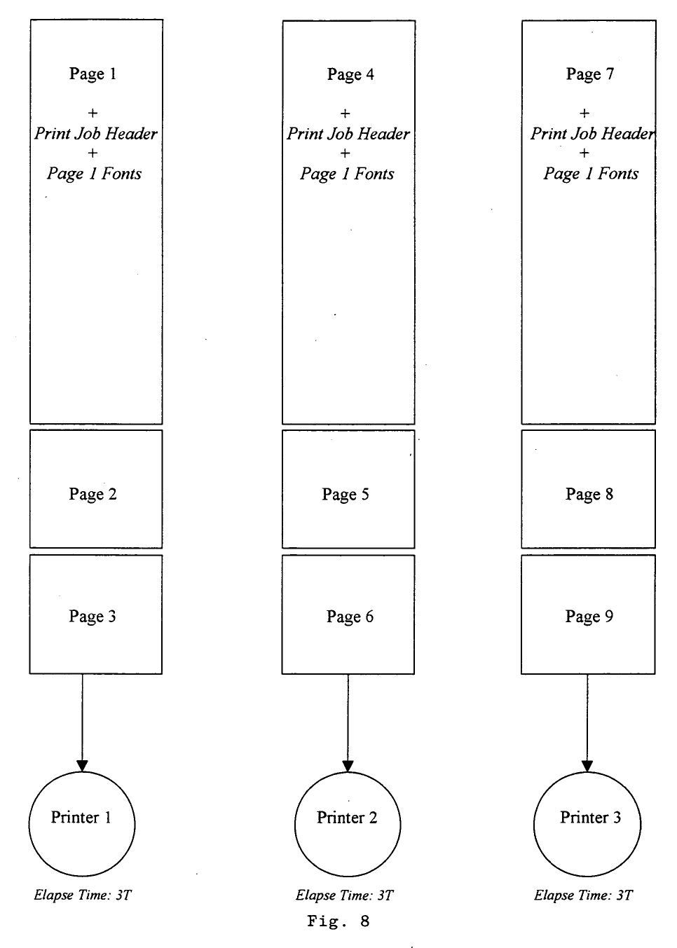

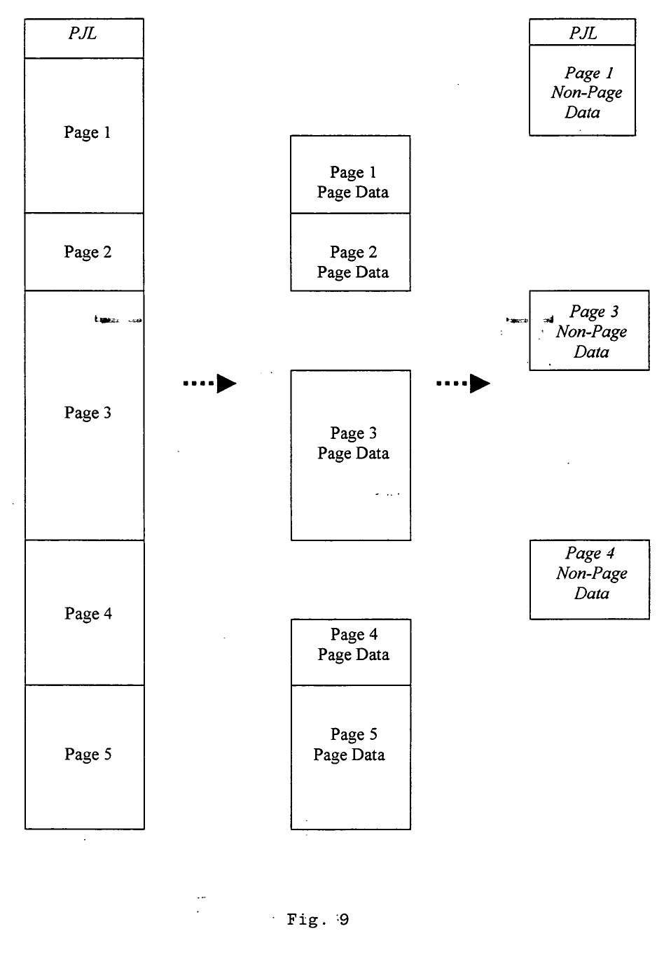

FIGS. 6-9 depict use of an embodiment of the method of the invention wherein document splitting is based on a load balance by page data size weighting protocol, which produces improved results wherein the assumption of the previous embodiment may be incorrect because a page typically includes page data and non-page data. The first page of a print job may also contain print job commands, e.g., print job language (PJL). Page data are those PDL commands that cause ink to be placed on paper, i.e., imaging. Non-Page data control the RIP and sheet assembly. For example, the first page typically begins with print job options, followed by a page preamble, which may specify the type of paper, orientation of the page on the paper, media type, resolution, followed by font set downloads, all of which are non-page data, and none of which will require consumption of any resources for RIP, because non-page data are only interpreted by the printer device.

In this embodiment of the method of the invention, the resources consumed for PDL interpretation are assumed to be insignificant to the resources consumed for RIP. The method of this embodiment improves on the previously described embodiment of the method of the invention and produces a more evenly distributed load by subtracting out all non-page print data from the page size.

For example, in a single-font, multi-page, text-only document, each page, except for the first page, likely contains very little data, e.g., text strings only. A 80×100 character document completely, filled with text, will only consume ˜8K in character data. By contrast, the first page, while containing very little data for the text, will contain the font download for the text font type used throughout the whole document. Because the font downloads must occur before the font is used, this data will occur in the first page. A font download includes the glyphs, i.e., character bitmaps, for each character in the font. The size of the font data is dependent on the pixel size and bit-depth resolution. For example, the Lexmark® Optra Postscript driver downloads 20K of gylph data for a single 12 point font. Larger point multi-fonts and more complex fonts, can increase the download to hundreds of thousands of bytes. Yet once the font is loaded, the time to RIP text strings on each page is the same.

The first step of load balancing by page data size is to split the print job into pages, and group the pages into sheets, as described earlier herein. The sheet size is decomposed into three categories: print job options, non-page data and page data. Each sheet is then weighted by the page-data size. Thus, the distribution of pages based on page data size may be calculated as:

TABLE 4
Load Balancing by Page Data Size

Sheet Sizeᵢ = Sheet PJL Sizeᵢ + Sheet Non-Page Data Sizesᵢ + Sheet Page Data Sizeᵢ

| | |
|---|---|
| ${Weight}_{Total} = {\sum }_{i = 1}^{M} Sheet Page Data {Size}_{j}$ | # Total Weight of all Page Data in the Document |

| | |
|---|---|
| for i =1 to N | # Distribution of Weight to each Printer in the Cluster |
| do | |

Weightᵢ = (PPMᵢ/PPM_{Total}) * Weight_{Total}

done

| Load Balance by Page Weighting | | Load Balance by Page Data Size |
|---|---|---|
| Document Splitting of Pages/Sheets: | Yes | Yes |
| Balanced Distribution for Equal Pages: | Yes | Yes |
| Balanced Distribution for Non-Equal | Yes | Yes |
| Pages: | | |
| Consideration of Print Job Header:Yes | Yes | |
| Consideration of Non-Page Data: | Yes | Yes |
| Consideration of Page Cmd Weighting: | Yes | No |

Document Splitting—Load Balance by Page Command Weights

The above load balancing by page data size method of the invention, while generally providing a better approximate even distribution than the load balancing by page/file size embodiment of the method of the invention, may again not always produce an evenly balanced distribution. The load balancing by page data size embodiment assumes that all page data commands are of equal size and consume equal resources. While this is a reasonable rule of thumb, it is not always true.

For example, page data may contain two vector fill commands in a row with the same fill. Because the fill is persistent, it may not need to be specified again in the second command. That is, the fill will default to the previous value. In this case, the commands may look something like:

| | |
|---|---|
| Download Fill Pattern | # download fill pattern to printer |
| Set Fill Pattern ID 1 | # assign identifier to fill pattern |
| Draw Box 0,0,10,20 with Fill ID 1 | # draw a box using the |
| | specified fill pattern |
| Draw Box 5,5,60,80 with Fill ID 1 | # draw a box using the |
| | previous fill pattern |

In the above example, the two vectorfill commands consume identical resources. Yet the first command, which required explicit specification of the fill pattern, is substantially larger in page data size, and will incorrectly contribute a substantially larger weight to the page than the second command.

Other page data commands may require equal amounts of page data, but consume substantially different resource requirements because of substantial differences in complexity. For example, a draw table command specifying a number of rows, columns, spacing and line widths is a very complex command to RIP. On the other hand, a text string command with a text caption of approximately equal length to the draw table command will take very few resources to RIP.

In this embodiment of the method of the invention, the resources consumed for PDL interpretation/RIP are assumed to be different for each page data command. The method of this embodiment improves on the previously described methods and produces a more evenly distributed load by weighting each page data command based on a command-specific weight, which is obtained from a page command weight profile.

In one form of this embodiment of the method of the invention, a standardized weight profile is used for general printing devices. In another embodiment, a printer specific, i.e., tuned, weight profile is used for specific printing devices.

TABLE 5

| | | Load Balance by |
|---|---|---|
| Load Balance by Page Weighting | | Page Cmd Weights |
| Document Splitting of Pages/Sheets: | Yes | Yes |
| Balanced Distribution for Equal Pages: | Yes | Yes |
| Balanced Distribution for Non-Equal | Yes | Yes |
| Pages: | | |
| Consideration of Print Job Header: | Yes | Yes |
| Consideration of Non-Page Data: | Yes | Yes |
| Consideration of Page Cmd Weighting: | Yes | Yes |

Other embodiments of the method of the invention include the spooling and despooling subsystems of the Apple® Macintosh® Operating System, Linux® Operating System, System V Unix® Operating Systems, BSD Unix® Operating Systems, OSF Unix® Operating Systems, and IBM® Mainframe MVS and OS/400 Operating Systems.

Thus, a method of load balanced document splitting by weighting pages has been disclosed. It will be appreciated that further variations and modifications thereof may be made within the scope of the invention as defined in the appended claims.

1. A method for distributing a print job having plural pages to plural printers, each printer having a printer description language interface, comprising:
selecting a cluster printing option and the printers to be used during distributed printing;
analyzing the print job to estimate print times for each page of the print job;
assigning a print job weight to each page as a function of the page's proportional page description language/raster image process time; and
balancing a page distribution to each selected printer as a function of a printer's rated speed to have the distributed print job substantially simultaneously complete on each selected printer.

2. The method of claim 1 wherein said assigning a print job weight includes load balancing by page size wherein a page description language/raster image process load is proportional to the size of a the print data for each page; and wherein the print job is split into print data for each page.

3. The method of claim 1 wherein said assigning a print job weight includes load balancing by page data size wherein each page of a print job is divided into page data and non-page data, wherein the non-page data is not considered; and wherein the print job is split into pages, a group of pages is split into sheets; and wherein the sheets are weighted as a function of page data size.

4. The method of claim 1 wherein said assigning a print job weight includes load balancing by page command weights.

5. The method of claim 1 wherein a print job is pre-processed into printer ready data.

6. The method of claim 1 wherein a print job is pre-processed into journaled data.

7. The method of claim 1 wherein said selecting a cluster printing option includes selecting options from the group of options consisting of cluster printing, document splitting, copy splitting and best fit/pool printing.

8. The method of claim 1 wherein said analyzing includes constructing print job specific information during compiling of rendering instructions, rendering, or recording the print job for deferred playback.

9. A method for distributing a print job having plural pages to plural printers, each printer having a printer description language interface, comprising:
selecting a cluster printing option and the printers to be used during distributed printing;
analyzing the print job to estimate print times for each page of the print job;
assigning a print job weight to each page as a function of the page's proportional page description language/raster image process time, wherein said assigning includes selecting a weighting technique taken from the group of techniques consisting of load balancing by page size, load balancing by page data size and load balancing by page command weights; and
balancing a page distribution to each selected printer as a function of a printer's rated speed to have the distributed print job substantially simultaneously complete on each selected printer.

10. The method of claim 9 wherein said load balancing by page size includes load balancing wherein a page description language/raster image process load is proportional to the size of a the print data for each page; and wherein the print job is split into print data for each page.

11. The method of claim 9 wherein said load balancing by page data size includes load balancing wherein each page of a print job is divided into page data and non-page data, wherein the non-page data is not considered; and wherein the print job is split into pages, a group of pages is split into sheets; and wherein the sheets are weighted as a function of page data size.

12. The method of claim 9 wherein said load balancing by page command weights includes load balancing as a function of the PDL interpretation/RIP times for each page.

13. The method of claim 9 wherein a print job is pre-processed into printer ready data.

14. The method of claim 9 wherein a print job is pre-processed into journaled data.

15. The method of claim 9 wherein said selecting a cluster printing option includes selecting options from the group of options consisting of cluster printing, document splitting, copy splitting and best fit/pool printing.

16. The method of claim 9 wherein said analyzing includes constructing print job specific information during compiling of rendering instructions, rendering, or recording the print job for deferred playback.
